(19) United States
(12) Patent Application Publication
(10) Pub. No.: US 2005/0221160 A1
(43) Pub. Date: Oct. 6, 2005

(54) Separator for fuel cell, method for preparing the same, and fuel cell comprising the same

(76) Inventors: Ju-Yong Kim, Suwon-si (KR); Dong-Hun Lee, Suwon-si (KR); Hyoung-Juhn Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/093,953

(22) Filed: Mar. 29, 2005

(30) Foreign Application Priority Data
Mar. 30, 2004 (KR) 10-2004-0021586

(51) Int. Cl. H01M 8/02; H01B 1/24; C08J 5/00

(52) U.S. Cl. 429/38; 252/511; 264/331.11

(57) ABSTRACT

A separator for a fuel cell contains nano-graphite thin plates with a thickness of about 3 to 30 nm or clusters of the nano-graphite thin plates. As such, the separator is capable of providing enough electrical conductivity with only a small amount of graphite, is light in weight, and has sufficient mechanical characteristics due to increased binding of graphite to resin, excellent resistance, and excellent thermal stability due to a reduction in the thermal expansion coefficient.

### CROSS REFERENCE TO RELATED APPLICATION

This application claims the benefit of Korean Patent Application No. 10-2004-0021586 filed in the Korean Industrial Property Office on Mar. 30, 2004, the entire content of which is incorporated herein by reference.

### BACKGROUND OF THE INVENTION

(a) Field of the Invention

The present invention relates to a separator (or a bipolar plate) for a fuel cell, which is capable of providing sufficient electrical conductivity with only a small amount of graphite, and that can be light-weight and have good mechanical characteristics, excellent resistance, and excellent thermal stability, and to a method for preparing the same.

(b) Description of the Related Art

A fuel cell, which is a device for directly generating electricity by an electrochemical reaction of hydrogen and oxygen, is characterized by the capability of generating electricity continuously with only an external supply of chemical reactants, rather than requiring a recharge.

While the concept of a fuel cell was proposed in the 18th century in England, the possible application of a fuel cell to cars and other devices has only been extensively studied since the 1990s and the development of a fuel cell for portable devices has recently begun to accelerate.

The basic structure of a fuel cell has an alternately stacked structure of two separators with a membrane-electrode assembly therebetween. The membrane-electrode assembly is composed of an electrode, a catalyst layer, and a thin film layer.

Since the separator supplies the hydrogen and oxygen to the membrane-electrode assembly layer, collects the electrical current, and protects against the danger of explosion and combustion resulting from the direct contact of hydrogen and oxygen, it should have low gas permeability and excellent electrical conductivity.

At present, graphite is widely used as a material for the separator. Specifically, graphite is mechanically pulverized into μm-sized particles and then mixed with a polymer resin, leading to a composite material for the separator.

For example, U.S. Pat. No. 6,248,467 discloses that a large amount of graphite of 20 to 60% by weight was mixed with a vinylester resin for preparing an electrically conductive separator. In addition, U.S. Pat. No. 4,592,968 discloses that approximately 60 to 40% by weight of graphite was mixed with 40 to 60% by weight of carbonized resin for preparing a composite material.

However, since these conventional approaches use graphite that are at least up to more than ten percent (10%) by weight to acquire the desired level of electrical conductivity, the separator material itself increases in both weight and viscosity, causing difficulty in stirring and fabricating the separator material as well as in achieving the desired level of strength, resistance, and stability of the final composite material.

### SUMMARY OF THE INVENTION

An aspect of the present invention is to provide a separator (or a bipolar plate, hereinafter also referred to as a separator) for a fuel cell, which is capable of providing enough electrical conductivity with only a small amount of graphite, and that can be light-weight and have good mechanical characteristics, excellent resistance, and excellent thermal stability.

Another aspect of the present invention is to provide a method for preparing the fuel cell separator.

Still another aspect of the present invention is to provide a fuel cell containing the fuel cell separator.

In one exemplary embodiment of the present invention, a fuel cell separator includes a resin and nano-graphite thin plates having a thickness in a range of nanometers within the resin.

In one exemplary embodiment of the present invention, a fuel cell separator includes a resin and clusters of nano-graphite thin plates. The clusters containing the nano-graphite thin plates has a thickness in a range of nanometers and the resin exists between the nano-graphite thin plates.

In one exemplary embodiment of the present invention a method for preparing a separator for a fuel cell is provided. The method includes: (a) pulverizing a crystalline graphite into μm-sized particles; (b) preparing nano-graphite thin plates or clusters of nano-graphite thin plates of a thickness in a range of nanometers using the μm-sized graphite particles; (c) drying the nano-graphite thin plates or the clusters of the nano-graphite thin plates; (d) dispersing the dried nano-graphite thin plates or the dried clusters of the nano-graphite thin plates in an alcohol; (e) mixing a resin with the alcohol dispersed with the nano-graphite thin plates or the clusters of the nano-graphite thin plates; (f) heating and stirring the nano-graphite thin plates or the clusters of the nano-graphite thin plates to evaporate the alcohol; and (g) pouring a resultant mixture of (f) into a mold to fabricate the separator for the fuel cell.

In one embodiment of the present invention, a fuel cell is provided. The fuel cell includes a membrane-electrode assembly having an electrolyte membrane interposed between an anode and a cathode, and at least one of the above described separators positioned on both sides of the membrane-electrode assembly.

### BRIEF DESCRIPTION OF THE DRAWINGS

FIG. 1 is a process flow diagram illustrating the procedure for the preparation of a separator for a fuel cell according to an exemplary embodiment of the present invention.

FIG. 2 is an exploded perspective view illustrating an exemplary embodiment of a fuel cell according to the present invention.

FIG. 3 is an electron microscopic photograph of nano-graphite thin plates according to Example 1 of the present invention.

### DETAILED DESCRIPTION

In the context of the present invention, a separator for a fuel cell can contain a conductive material within a resin. The conductive material can include nano-graphite thin plates having a thickness in a range of nanometers. In addition, the range of nanometers (or nanometer range) can typically be equal to or less than hundreds of nanometers.

According to an exemplary embodiment of the present invention, the separator contains, as a conductive material, nano-graphite thin plates with a thickness in the range of nanometers, which can be about 3 to 50 nm or about 3 to 30 nm.

In an exemplary embodiment of the present invention, while the separator has nano-graphite thin plates evenly dispersed within resin, the weight ratio of the resin and the nano-graphite thin plates should be about 99:1 to 90:10 or about 99:1 to 99:5. That is, while a ratio of less than 99:1 results in a separator with unsatisfactory performance, a ratio of more than 90:10 leads to a separator with reduced resistance, a shortened lifetime, and an increased weight.

In the present invention, the resin contained in a separator is not restricted to any specific resin, and can be one or more resins selected from epoxy-type resins, ester-type resins, vinylester-type resins, and/or urea-type resins. In addition, a separator for a fuel cell may include an additional acid or metal introduced during the process for preparing nano-graphite thin plates. Moreover, a separator for a fuel cell can include clusters of nano-graphite thin plates, which contain nano-graphite thin plates with a thickness in the range of nanometers and a resin existing among the nano-graphite thin plates. The thickness of the clusters of nano-graphite thin plates should be less than or equal to about 5 μm, or about 3 nm to 1 μm.

In an embodiment of the present invention, a separator includes a mixture of clusters of nano-graphite thin plates and a binder resin, or a mixture with the clusters of the nano-graphite thin plates evenly dispersed within the binder resin. The binder can be the same material or different from the resin of nano-graphite thin plates or clusters thereof. The weight ratio of the resin and the clusters of nano-graphite thin plates contained in the separator should be about 99:1 to 90:10 or about 99:1 to 99:5. That is, while a ratio of less than about 99:1 results in a separator with unsatisfactory performance, a ratio of more than 90:10 leads to a separator with reduced resistance, a shortened lifetime, and an increased weight.

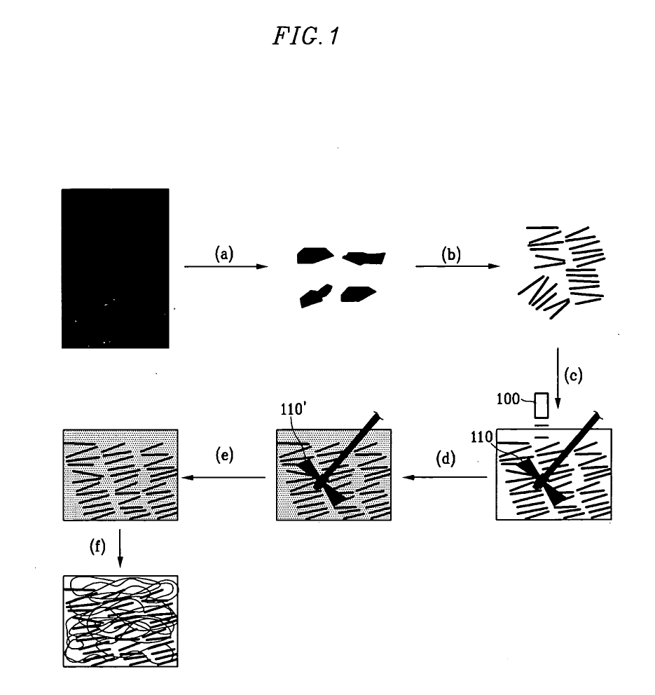

FIG. 1 is the process flow diagram schematically illustrating the procedure for preparing a separator for a fuel cell according to an exemplary embodiment of the present invention.

In FIG. 1, first, crystalline graphite is mechanically pulverized into μm-sized graphite particles (a). The resultant graphite particles are treated with acid or a metal (b) to prepare nano-graphite thin plates with a thickness in the range of nanometers or clusters of the resultant nano-graphite thin plates.

As an example of the methods of treating with acid, the μm-sized graphite particles are impregnated in an acid solution chosen from the group including sulfuric acid, hydrochloric acid, nitric acid, etc. to prepare nano-graphite thin plates. The graphite particles impregnated in the acid solution can also be fast-heated to about 200 to 300° C. in an oven and allowed to sit for a sufficient time to prepare nano-graphite thin plates. The impregnation time can be more than about 12 hours.

As an example of the methods of treating with a metal, the μm-sized graphite particles are mixed with a metal and heated, followed by mixing with water and alcohol to prepare nano-graphite thin plates. The metal should be one or more alkali metals selected from potassium, sodium, lithium, etc. The heating temperature should be about 100° C., at which the resultant mixture should be allowed to sit for about 20 to 25 hours. In addition, the heating should be carried out under vacuum or an inert gas atmosphere of argon (Ar), helium (He), etc.

Referring now still to FIG. 1, the resultant nano-graphite thin plates with a thickness in the range of nanometers or the clusters of the nano-graphite thin plates are dried to remove water and then mixed in an alcohol, being evenly dispersed by supersonic waves, e.g., using a wave generator 100, or mechanical stirring, e.g., using a mechanical stirrer 110(c). The alcohol may be an aliphatic alcohol containing about 1 to 5 carbons, or one or a mixture of two or more of isopropanol, ethanol, methanol, etc.

The alcohol is dispersed with the nano-graphite thin plates or the clusters of the nano-graphite thin plates is added with a resin, followed by stirring at a high speed, e.g., using a mechanical stirrer 110′, and heating to evaporate the alcohol solvent (d).

When the alcohol solvent has substantially or completely evaporated, the remaining resultant mixture is poured into a mold (e), followed by addition of a solidifying agent to solidify the resin (f), leading to the preparation of a separator for a fuel cell according to the exemplary embodiment of the present invention.

In accordance with certain embodiments of the present invention, a separator prepared by the above described exemplary methods can be applied to any type of fuel cells. In one embodiment, the separator is applied to a polymer electrolyte membrane fuel cell (PEMFC). In another embodiment, the separator is applied to a direct methanol fuel cell (DMFC).

In one embodiment of the present invention, a fuel cell includes a membrane-electrode assembly (MEA), where an electrolyte membrane is flanked by an anode and a cathode on respective sides thereof, and separators prepared by the above described exemplary methods are positioned on both sides of the MEA.

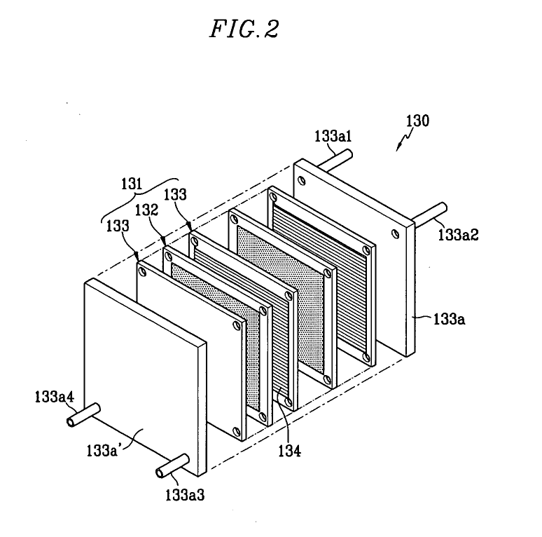

Referring now to FIG. 2, a fuel cell according to an exemplary embodiment of the present invention includes an MEA 132 where a reduction/oxidation reaction of oxygen and a hydrogen-containing fuel occurs, and separators 133 for providing fuel and air to the MEA132. The separators 133 are positioned on respective sides of the MEA 132.

The fuel cell may be used in a single cell or in a stack of two or more cells, in which the separators at both extremes of the fuel cell are called the end plates 133a, 133a′.

The MEA 132 includes an electrolyte membrane interposed between an anode and a cathode.

The anode, the component in a cell to which the hydrogen gas fuel is supplied through a separator 133, includes a catalyst layer for splitting hydrogen gas into electrons and protons by an oxidation reaction, and a gas diffusion layer (GDL) for efficiently diffusing the electrons and the protons.

In contrast, the cathode, the component in a cell to which air is supplied through a separator 133, includes a catalyst layer for reducing oxygen in the air into oxygen ions by a reduction reaction and a gas diffusion layer (GDL) for efficiently diffusing the electrons and the oxygen ions.

The electrolyte membrane is a solid polymer electrolyte with a thickness of about 50 to 200 μm, and it functions as an ion exchanger by transferring the protons (or hydrogen ions) generated in the catalyst layer of the anode to the catalyst layer of the cathode.

The separators 133 function as conductors by serially connecting the anode and the cathode in the MEA 132. In addition, the separators 133 function as tunnels through which the anode and cathode are supplied with hydrogen gas and air required for an oxidation/reduction reaction in the MEA 132. For this reason, flow channels 134 are formed on the surfaces of the separators 133 for supplying gases required for an oxidation/reduction reaction in the MEA 132.

More specifically, the separators 133 positioned on both sides of the MEA 132 are in close contact with the anode and the cathode.

Moreover, while one or an input end plate 133a of the separators may be equipped with a first supplier 133a1 for supplying the fuel (or hydrogen) and a second supplier 133a2 for supplying air (or oxygen), the other or an output end plate 133a′ may be equipped with a first exhaust 133a3 for releasing the fuel not consumed in the unit cell 131 of a single cell or multiple cells after the final reaction and a second exhaust 133a4 for releasing the oxygen left unreacted in the unit cell 131 after the final reaction.

While the fuel cell containing the separators according to the present invention is not restricted to a specific type of fuel cell, in one embodiment of the invention, the fuel cell is a PEMFC and, in another embodiment of the invention, the fuel cell is a DMFC.

The following examples illustrate the present invention in further detail and are provided for exemplary purposes. Thus, the present invention is not limited to the following examples.

### EXAMPLES

### Example 1

To prepare nano-graphite thin plates with an acid treatment, a ball mill was used to pulverize about 5 g of crystalline graphite into μm-sized particles. The pulverized particles were impregnated with about 100 g of about 1 M H₂SO₄, fast-heated to about 250° C. in an oven, and allowed to sit for about 20 hours, then dried at about 150° C. to prepare the nano-graphite thin plates.

### Example 2

To prepare nano-graphite thin plates with an alkali metal treatment, a ball mill was used to pulverize about 5 g of crystalline graphite into μm-sized particles. The pulverized particles were mixed with about 2 g potassium and allowed to sit at about 100° C. for about 24 hours. The resulting potassium intercalated golden-colored mixture was added with water and alcohol and then stirred for about 30 minutes, followed by drying at about 150° C. to prepare the nano-graphite thin plates.

### Example 3

To prepare a separator for a fuel cell containing the nano-graphite thin plates of Example 1, the nano-graphite thin plates prepared in Example 1 were added with about 5 g isopropanol and dispersed by stirring supersonically and/or mechanically at high speed (about 10,000 rpm). Afterward, about 95 g epoxy resin was added to the isopropanol suspension where the nano-graphite thin plates were dispersed, the isopropanol was evaporated while stirring at about 60° C. at a high speed. The resulting mixture was poured into a mold and mixed with ‘Epicure w/’ (manufactured by Shell LTD.) as a solidifying reagent to prepare the separator for the fuel cell.

### Example 4

To prepare a separator for a fuel cell containing the nano-graphite thin plates of Example 2, the separator for the fuel cell was prepared in the same method as in Example 3, except that about 2.5 g of the nano-graphite thin plates prepared in Example 2 were added thereto.

### Comparative Example 1

In a Comparative Example 1, a separator for a fuel cell containing μm-sized graphite particles was prepared in the same method as in Example 3, except that about 5 g of crystalline graphite pulverized into μm-sized particles was used (and without the preparation of nano-graphite thin plates with an acid treatment of Example 1).

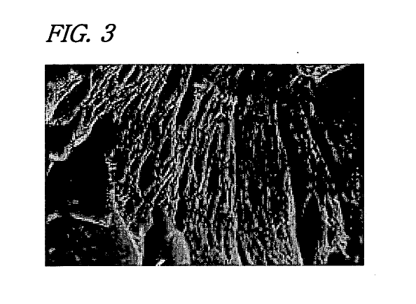

An electron microscopic picture of clusters containing nano-graphite thin plates prepared according to Example 1 is illustrated in FIG. 3. From FIG. 3, formation of clusters of nano-graphite thin plates are confirmed.

In addition, the measured electrical conductivity and mechanical strength of the separator for a fuel cell prepared according to Examples 3 and 4 and Comparative Example 1 are shown in Table 1.

TABLE 1

| | Electrical conductivity | Mechanical strength |
|---|---|---|
| | (S/cm) | (MPa) |
| Example 3 | 10⁻⁶ | 110 |
| Example 4 | 10⁻⁶ | 110 |
| Comparative | 10⁻¹² | 110 |
| Example 1 | | |

As shown in Table 1, the separators for a fuel cell of Examples 3 and 4 are capable of providing enough electrical conductivity compared to Comparative Example 1 while maintaining equivalent mechanical strength.

As described above, since a separator for a fuel cell contains nano-graphite thin plates with a thickness in the range of nanometers or clusters of the nano-graphite thin plates, the separator for the fuel cell according to certain embodiments of the present invention is capable of providing enough electrical conductivity with only a small amount of graphite, can be light in weight, and have sufficient mechanical characteristics (e.g., due to the increased binding of graphite to resin), excellent resistance, and excellent thermal stability (e.g., due to a reduction in the thermal expansion coefficient).

While the present invention has been described in connection with certain exemplary embodiments, it is to be understood that the invention is not limited to the disclosed embodiments, but, on the contrary, is intended to cover various modifications included within the spirit and scope of the appended claims and equivalents thereof.

1. A separator for a fuel cell comprising:
a resin; and
nano-graphite thin plates having a thickness in a range of nanometers within the resin.

2. The separator for the fuel cell according to claim 1, wherein the thickness of the nano-graphite thin plates is about 3 to 50 nm.

3. The separator for the fuel cell according to claim 2, wherein the thickness of the nano-graphite thin plates is about 3 to 30 nm.

4. The separator for a fuel cell according to claim 1, wherein a weight ratio of the resin and the nano-graphite thin plates ranges from about 99:1 to 90:10.

5. The separator for the fuel cell according to claim 4, wherein the weight ratio of the resin and the nano-graphite thin plates ranges from about 99:1 to 95:5.

6. The separator for the fuel cell according to claim 1, wherein the resin comprises one or more resin materials selected from the group consisting of epoxy-type resin materials, ester-type resin materials, vinylester-type resin materials, and urea-type resin materials.

7. The separator for a fuel cell according to claim 1, further comprising an acid or a metal introduced during the preparation of nano-graphite thin plates.

8. A separator for a fuel cell comprising:
a resin; and
clusters of nano-graphite thin plates,
the clusters of the nano-graphite thin plates having a thickness in a range of nanometers and the resin existing between the nano-graphite thin plates.

9. The separator for the fuel cell according to claim 8, wherein a thickness of the clusters of the nano-graphite thin plates is less than or equal to about 5 μm.

10. The separator for the fuel cell according to claim 9, wherein the thickness of the clusters of the nano-graphite thin plates is about 3 nm to 1 μm.

11. The separator for the fuel cell according to claim 8, wherein the resin is made of at least one resin selected from the group consisting of epoxy-type resins, ester-type resins, vinylester-type resins, and urea-type resins.

12. The separator for the fuel cell according to claim 8, further comprising an acid or a metal introduced during the preparation of the clusters of the nano-graphite thin plates.

13. A method for preparing a separator for a fuel cell, the method comprising:
(a) pulverizing a crystalline graphite into μm-sized particles;
(b) preparing nano-graphite thin plates or clusters of nano-graphite thin plates with a thickness in the range of nanometers using the μm-sized graphite particles;
(c) drying the nano-graphite thin plates or the clusters of the nano-graphite thin plates;
(d) dispersing the dried nano-graphite thin plates or the dried clusters of the nano-graphite thin plates in an alcohol;
(e) mixing a resin with the alcohol dispersed with the nano-graphite thin plates or the clusters of the nano-graphite thin plates
(f) heating and stirring the nano-graphite thin plates or the clusters of the nano-graphite thin plates to evaporate the alcohol; and
(g) pouring a resultant mixture of (f) into a mold to fabricate the separator for the fuel cell.

14. The method according to claim 13, wherein the nano-graphite thin plates or the clusters of the nano-graphite thin plates prepared in b) is prepared by impregnating the 1 μm-sized particles pulverized in a) with an acid solution.

15. The method according to claim 13, wherein the nano-graphite thin plates or clusters of the nano-graphite thin plates prepared in b) is prepared by impregnating the μm-sized particles pulverized in a) with an acid solution, and then heating at a temperature of about 200 to 300° C.

16. The method according to claim 14, wherein the acid solution comprises one or more acids selected from the group consisting of sulfuric acid, hydrochloric acid, and nitric acid.

17. The method according to claim 13, wherein the nano-graphite thin plates or the clusters of the nano-graphite thin plates prepared in b) is prepared by mixing the μm-sized particles pulverized in a) with a metal under an inert atmosphere and then heating the μm-sized particles with the metal, followed by adding a water and alcohol solution thereto.

18. The method according to claim 17, wherein the metal comprises one or more alkali metals selected from the group consisting of potassium, sodium, and lithium.

19. A fuel cell comprising:
a membrane-electrode assembly having an electrolyte membrane interposed between an anode and a cathode; and
a separator positioned on both sides of the membrane-electrode assembly,
the separator comprising:
a resin; and
nano-graphite thin plates having a thickness in a range of nanometers within the resin.

20. The fuel cell according to claim 19, wherein the fuel cell is a polymer electrolyte membrane fuel cell (PEMFC) or a direct methanol fuel cell (DMFC).

21. A fuel cell comprising:
a membrane-electrode assembly having an electrolyte membrane interposed between an anode and a cathode; and
a separator positioned on both sides of the membrane-electrode assembly,
the separator comprising:
a resin; and
clusters of nano-graphite thin plates,
the clusters of the nano-graphite thin plates having a thickness in a range of nanometers and the resin existing between the nano-graphite thin plates.

22. The fuel cell according to claim 21, wherein the fuel cell is a polymer electrolyte membrane fuel cell (PEMFC) or a direct methanol fuel cell (DMFC).
